(19) United States
(12) Patent Application Publication
(10) Pub. No.: US 2024/0198304 A1
(43) Pub. Date: Jun. 20, 2024

(54) Color Mixing Device

(71) Applicant: Zhengzhou Sanhua Technology & Industry Co., Ltd., Xingyang City (CN)

(72) Inventors: Ruhua SHEN, Xingyang City (CN); Kunkun ZHANG, Xingyang City (CN)

(21) Appl. No.: 18/540,933

(22) Filed: Dec. 15, 2023

(30) Foreign Application Priority Data
Dec. 19, 2022 (CN) 202211638508.5

(51) Int. Cl. B01F 33/84; B01F 35/40

(52) U.S. Cl. CPC B01F 33/844; B01F 35/40; B01F 2101/30

(57) ABSTRACT

A color mixing device is provided. The color mixing device includes: a mounting cabinet, a plurality of injection assemblies, a conveying assembly, a drive part, and a controller. A sliding table assembly arranged in a first direction is mounted in the mounting cabinet. The plurality of injection assemblies are arranged in the mounting cabinet in rows and columns. Each injection assembly has a material storage cavity and a discharge nozzle communicated with the material storage cavity. The conveying assembly is movably arranged on the sliding table assembly in the first direction. The conveying assembly has a mounting station and an injection station relative to the mounting cabinet. When the conveying assembly is positioned at the injection station, the each injection assembly positioned on the conveying assembly is capable of injecting a material through a corresponding discharge nozzle.

### CROSS-REFERENCE TO RELATED APPLICATION(S)

The present disclosure claims priority to patent application No. 202211638508.5, filed to the China National Intellectual Property Administration on Dec. 19, 2022 and entitled “Color Mixing Device”.

### TECHNICAL FIELD

The present disclosure relates to the technical field of automatic mixing of colored liquid, and in particular, to a color mixing device.

### BACKGROUND

A basic principle of various types of car paint, oil paint, latex paint, or ink is to mix various color master batches and auxiliary materials according to formulas and finally obtain required paint. In addition to the most traditional manual mixing by paint mixers, there are also increasingly popular paint mixing equipment in various forms in a current paint mixing process. The paint mixing equipment generally includes a plurality of color master batch barrels and ingredient conveying modules. Color master batches are discharged from different color master batch barrels by the ingredient conveying modules according to a formula, and are mixed in a relevant container to obtain the required paint.

Nowadays, there are more and more customers in the market for personalized customization of various types of paint. Meeting this demand means that the color mixing equipment can store various color master batch barrels in a constant environment, so as to ensure that the color master batches do not deteriorate due to repeated exposure to air. A type of color mixing equipment in the market includes a rectangular color master batch storage cabinet, and m*n color master batch barrels are placed in one plane in the color master batch storage cabinet. A discharge actuating mechanism for quantitatively injecting color master batches in the color master batch barrels is disposed on a side of the color master batch storage cabinet. In order to convey the color master batch barrels to the discharge actuating mechanism, a set of manipulator part will be arranged in the color master batch storage cabinet. Generally, a worker selects a color master batch barrel according to the formula and places the color master batch barrel at a pre-discharge station first, and then the color master batch barrel is moved from the pre-discharge station to the discharge actuating mechanism by using the manipulator part. There are also turntable type color mixers. A plurality of color master batch barrels and pump valve mechanisms connected with the color master batch barrels are arranged on a turntable of a mixer body. An injection mechanism for controlling the pump valve mechanisms to open and close is arranged on the mixer body. The turntable rotates to rotate the color master batch barrels that need to inject to the injection mechanism to inject corresponding color master batches separately. A plurality of color master batches are injected and mixed in sequence to obtain required paint. These two types of color mixing equipment can complete paint mixing work in corresponding scenarios. However, the first type of equipment that uses the manipulator part has the situations of large structure, relatively complex structure, and high cost; and the second type of turntable type equipment has a simple and mature structure, but the number of color master batch barrels that can be mounted on the turntable is certain. If the number of the mounted color master batch barrels is increased by increasing the area of the turntable, it will lead to problems of complex mounting and larger overall volume.

### SUMMARY

Some embodiments of the present disclosure provide a color mixing device. The color mixing device is simple in structure and low cost, and can carry a large number of injection assemblies.

Some embodiments of the present disclosure provide a color mixing device, including: a mounting cabinet, a plurality of injection assemblies, a conveying assembly, a drive part, and a controller. A sliding table assembly arranged in a first direction is mounted in the mounting cabinet. The plurality of injection assemblies are arranged in the mounting cabinet in rows and columns. In a height direction of the mounting cabinet, the injection assemblies are arranged on at least one side of the sliding table assembly. Each injection assembly has a material storage cavity capable of storing a material and a discharge nozzle communicated with the material storage cavity. The conveying assembly is mounted in the mounting cabinet. The conveying assembly is movably arranged on the sliding table assembly in the first direction. The conveying assembly has a mounting station and an injection station relative to the mounting cabinet. When the conveying assembly is positioned at the mounting station, at least one injection assembly can be mounted on the conveying assembly; and when the conveying assembly is positioned at the injection station, the injection assembly positioned on the conveying assembly can inject a material through a corresponding discharge nozzle. The drive part is connected with the conveying assembly. The drive part is arranged to drive the conveying assembly to move, so that the conveying assembly is switched between the mounting station and the injection station. The controller is connected with the drive part and controls the drive part.

In some embodiments, the sliding table assembly includes a support frame and two support rails arranged on the support frame. Each support rail extends in the first direction. The two support rails are arranged at an interval in a second direction perpendicular to the first direction. The conveying assembly includes a mounting structure and two sliding chutes formed in two sides of the mounting structure. The two sliding chutes are arranged corresponding to the two support rails. The sliding chutes are in sliding fit with the support rails.

In some embodiments, each support rail includes a plurality of first rolling pieces arranged in the first direction at intervals; and the plurality of first rolling pieces are rotatably arranged on the support frame.

In some embodiments, the each support rail further includes a plurality of fixed shafts and an anti-dropping plate. The plurality of fixed shafts are arranged on the support frame along the second direction in a penetrating manner. The plurality of fixed shafts are arranged corresponding to the plurality of first rolling pieces. Each first rolling piece is rotatably arranged on a periphery of the corresponding fixed shaft. The anti-dropping plate is arranged to connect the plurality of fixed shafts, and the plurality of first rolling pieces are positioned between the anti-dropping plate and the support frame.

In some embodiments, the sliding table assembly further includes a compression component positioned above each support rail and arranged on the support frame. When the conveying assembly is positioned at the injection station, the compression component is capable of compressing against the injection assembly.

In some embodiments, the compression component includes a plurality of second rolling pieces and a connecting piece. The plurality of second rolling pieces are arranged in the first direction in sequence. Each second rolling piece is rotatably connected with the connecting piece, and the each second rolling piece is mounted on the support frame through the connecting piece.

In some embodiments, the compression component further includes two guide pieces, connected with the support frame. The two guide pieces are arranged in the first direction at an interval, and the two guide pieces are respectively positioned on two sides of the plurality second rolling pieces.

In some embodiments, the drive part includes a belt, a mounting frame, a drive motor, a belt pulley, and an auxiliary wheel. The belt is fixed to an interior of the mounting cabinet. The belt extends in the first direction. The mounting frame is positioned on a side of the conveying assembly and is connected with the conveying assembly. The drive motor is mounted on the conveying assembly through the mounting frame. The controller is connected with the drive motor and is able to control the drive motor. The belt pulley is in transmission connection with an output end of the drive motor. The output end is capable of driving the belt pulley to rotate relative to the conveying assembly. The auxiliary wheel is rotatably arranged on the mounting frame. In the first direction, the auxiliary wheel is arranged on at least one side of the belt pulley. Part of the belt winds the belt pulley and the auxiliary wheel, so that the belt pulley and the auxiliary wheel are able to drive the conveying assembly to move in the first direction.

In some embodiments, the conveying assembly further includes a plurality of fixed frames arranged on the mounting structure. The plurality of fixed frames are arranged in the first direction. A mounting groove and an opening communicated with mounting groove are formed in each fixed frame. Each injection assembly is capable of being inserted in the mounting groove through the opening.

In some embodiments, the each fixed frame includes three connecting plates connected in sequence. Two adjacent connecting plates are arranged at an included angle. The three connecting plates enclose to form a U-shaped structure with the opening. The each fixed frame further includes two guide plates respectively connected with the first connecting plate and the third connecting plate of the three connecting plates. The two guide plates are respectively arranged at an angle with a correspondingly connecting plate. From the mounting groove to the opening, a spacing distance between the two guide plates gradually increases.

In some embodiments, the first connecting plate and the third connecting plate of the three connecting plates are respectively connected with the mounting structure. There is a spacing distance between a second connecting plate of the three connecting plates and the mounting structure.

In some embodiments, the color mixing device further includes a plurality of position sensors arranged corresponding to the plurality of fixed frames. The plurality of position sensors are connected with the controller and are controlled by the controller. The controller controls the conveying assembly to move according to information transmitted by the plurality of position sensors.

In some embodiments, each position sensor is arranged on a side, deviating from the fixed frame, of the mounting structure. A plurality of through grooves arranged corresponding to detection ends of the plurality of position sensors are formed in the mounting structure.

In some embodiments, the mounting cabinet includes a first cabinet body and a second cabinet body positioned on at least one side of the first cabinet body. A plurality of partition plates arranged at intervals in a vertical direction are arranged in each second cabinet body. One of the partition plates is arranged to mount part of the sliding table assembly. The rest partition plates are arranged to support the plurality of injection assemblies. The first cabinet body is arranged to mount a rest part of the sliding table assembly. A material falling channel communicated with an interior of the first cabinet body is formed in the first cabinet body. When the conveying assembly is positioned at the injection station, the discharge nozzle is communicated with the material falling channel.

By applying the technical solution of the present disclosure, in one aspect, compared with moving the injection assembly from a pre-discharge station to a position of a discharge actuating mechanism by using a manipulator part in the related technology, in the present embodiment, the sliding table assembly arranged in the first direction and the conveying assembly movably arranged on the sliding table assembly are arranged, so that the conveying assembly has the mounting station and the injection station relative to the mounting cabinet, and the drive part is arranged to drive the conveying assembly to switch between the mounting station and the injection station. In this way, the injection assembly may be moved from the mounting station (the pre-discharge station) to the injection station (the position of the discharge actuating mechanism) without the manipulator part, so as to simplify the structure of the color mixing device and reduce the size of the color mixing device, thereby reducing the production cost of the color mixing device. In another aspect, compared with a turntable type color mixing device in the related technology, in the present embodiment, the mounting cabinet is mounted, and the plurality of injection assemblies can be arranged inside the mounting cabinet in rows and columns. In this way, the problem of complexity of a drive mechanism and a transmission mechanism caused by increasing the size of a turntable can be avoided in a case that a large number of injection assemblies can be placed, so as to simplify the structure of the color mixing device and reduce the size of the color mixing device.

### BRIEF DESCRIPTION OF THE DRAWINGS

The drawings, which constitute a part of this application, are used to provide a further understanding of the present disclosure, and the exemplary embodiments of the present disclosure and the description thereof are used to explain the present disclosure, but do not constitute improper limitations to the present disclosure. In the drawings:

FIG. 1 illustrates a schematic structural diagram of one direction of an embodiment of a color mixing device of the present disclosure;

FIG. 2 illustrates a schematic structural diagram of another direction of the color mixing device in FIG. 1;

FIG. 3 illustrates a schematic structural diagram of another direction of the color mixing device in FIG. 1;

FIG. 4 illustrates a schematic structural diagram of another direction of the color mixing device in FIG. 1;

FIG. 5a illustrates a schematic diagram of an assembly structure of a conveying assembly, a lifting mechanism, and a drive part of the color mixing device in FIG. 1;

FIG. 5b illustrates a partially enlarged diagram of the drive part in FIG. 5a;

FIG. 6 illustrates a schematic diagram of an assembly structure of the conveying assembly, the lifting mechanism, and the drive part in FIG. 5a in another view;

FIG. 7 illustrates a schematic diagram of an assembly structure of the conveying assembly, the lifting mechanism, and the drive part in FIG. 5a in another view;

FIG. 8 illustrates a schematic structural diagram of a sliding table assembly of the color mixing device in FIG. 1;

FIG. 9 illustrates a schematic structural diagram of the sliding table assembly in FIG. 8 in another direction;

FIG. 10 illustrates a schematic structural diagram of a conveying assembly of the color mixing device in FIG. 1;

FIG. 11 illustrates a vertical view of the conveying assembly in FIG. 10;

FIG. 12 illustrates a bottom view of the conveying assembly in FIG. 11 after being rotated by 180°;

FIG. 13 illustrates a schematic diagram of an assembly structure of the lifting mechanism and a cleaning box assembly of the color mixing device in FIG. 1;

FIG. 14 illustrates a rear view of the lifting mechanism in FIG. 13;

FIG. 15 illustrates one schematic structural diagram of the cleaning box assembly in FIG. 13;

FIG. 16 illustrates another schematic structural diagram of the cleaning box assembly in FIG. 13;

FIG. 17 illustrates one schematic diagram of an assembly structure of an electronic scale and a lifting platform of the color mixing device in FIG. 1;

FIG. 18 illustrates a rear view of the electronic scale and the lifting platform in FIG. 17;

FIG. 19 illustrates a vertical view of the electronic scale and the lifting platform in FIG. 17;

FIG. 20 illustrates a schematic structural diagram of an injection assembly of the color mixing device in FIG. 1 in one direction;

FIG. 21 illustrates a schematic structural diagram of an injection assembly of the color mixing device in FIG. 1 in another direction;

FIG. 22 illustrates a schematic diagram of an assembly structure of a compression component and an injection assembly of the color mixing device in FIG. 1 in one direction; and

FIG. 23 illustrates a schematic diagram of an assembly structure of a compression component and an injection assembly of the color mixing device in FIG. 1 in another direction.

The above drawings include the following reference signs:

1, first cabinet body; 1-1, sliding table assembly; 1-1-1, support frame; 1-1-2, support rail; 1-1-3, compression component; 1-1-5, connecting piece; 1-1-6, guide piece; 1-2, conveying assembly; 1-2-1, mounting structure; 1-2-2, sliding chute; 1-2-3, fixed frame; 1-2-4, position sensor; 1-2-5, drive motor; 1-2-6, auxiliary wheel; 1-2-7, belt pulley; 1-2-8, anti-dropping plate; 1-2-9, guide plate; 1-3, lifting mechanism mounting part; 1-3-1, toggle rod of toggle valve body; 1-3-2, valve motor; 1-3-3, linear drive mechanism; 1-3-4, pull rod head baffle; 1-3-5, lead screw; 1-3-6, nut; 1-3-7, cleaning box assembly; 1-3-8, servo motor; 2, mounting cabinet; 2-1, second cabinet body; 2-2, partition plate; 4, injection assembly; 4-1, color master batch barrel; 4-2, valve body; 4-2-1, discharge nozzle; 4-2-2, valve body toggle rod; 4-3, pump; 4-3-1, piston rod; 4-4, base; 4-5, liquid replenishment tank; 5, belt; 6, electronic scale; and 7, lifting platform.

### DETAILED DESCRIPTION OF THE EMBODIMENTS

It is to be noted that in the case of no conflict, the features in the embodiments and the embodiments in the present application may be combined with each other. The present disclosure is described below with reference to the drawings and in conjunction with the embodiments in detail.

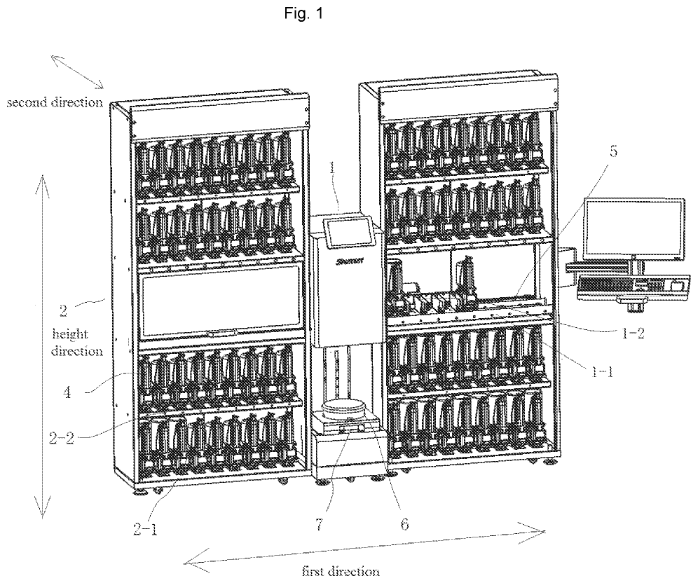

It is to be noted that, as shown in FIG. 1, in the embodiment of the present disclosure, a first direction is a length direction of a mounting cabinet 2, a second direction is a width direction of the mounting cabinet 2, and both the first direction and the second direction are perpendicular to a height direction of the mounting cabinet 2.

It is to be noted that, in the embodiments of the present disclosure, an injection assembly 4 is a color master batch barrel assembly for providing paint.

As shown in FIG. 1 to FIG. 4 and FIG. 21, the embodiments of the present disclosure provides a color mixing device. The color mixing device includes a mounting cabinet 2, a plurality of injection assemblies 4, a conveying assembly 1-2, a drive part, and a controller. A sliding table assembly 1-1 arranged in a first direction is mounted in the mounting cabinet 2. The plurality of injection assemblies 4 are arranged in the mounting cabinet 2 in rows and columns. In the height direction of the mounting cabinet 2, the injection assemblies 4 are arranged on at least one side of the sliding table assembly 1-1. Each injection assembly 4 has a material storage cavity and a discharge nozzle 4-2-1 communicated with the material storage cavity. The conveying assembly 1-2 is mounted in the mounting cabinet 2. The conveying assembly 1-2 is movably arranged on the sliding table assembly 1-1 in the first direction. The conveying assembly 1-2 has a mounting station and an injection station relative to the mounting cabinet 2. When the conveying assembly 1-2 is positioned at the mounting station, at least one injection assembly 4 can be mounted on the conveying assembly 1-2; and when the conveying assembly 1-2 is positioned at the injection station, the at least one injection assembly 4 positioned on the conveying assembly 1-2 can inject a material through a corresponding discharge nozzle 4-2-1. The drive part is connected with the conveying assembly 1-2. The drive part is arranged to drive the conveying assembly 1-2 to move, so that the conveying assembly 1-2 is switched between the mounting station and the injection station. The controller is connected with the drive part and is able to control the drive part.

In the above technical solution of the present disclosure, in one aspect, compared with moving the injection assembly 4 from a pre-discharge station to a position of a discharge actuating mechanism by using a manipulator part in the related technology, in the present embodiment, the sliding table assembly 1-1 arranged in the first direction and the conveying assembly 1-2 movably arranged on the sliding table assembly 1-1 are arranged, so that the conveying assembly 1-2 has the mounting station and the injection station relative to the mounting cabinet 2, and the drive part is arranged to drive the conveying assembly 1-2 to switch between the mounting station and the injection station. In this way, the injection assembly 4 may be moved from the mounting station (the pre-discharge station) to the injection station (the position of the discharge actuating mechanism) without the manipulator part, so as to simplify the structure of the color mixing device and reduce the size of the color mixing device, thereby reducing a production cost of the color mixing device. In another aspect, compared with a turntable type color mixing device in the related technology, in the present embodiment, the mounting cabinet 2 is mounted, and the plurality of injection assemblies 4 can be arranged inside the mounting cabinet 2 in rows and columns. In this way, the problem of complexity of a drive mechanism and a transmission mechanism caused by increasing the size of a turntable can be avoided in a case that a large number of injection assemblies 4 are placed, so as to simplify the structure of the color mixing device and reduce the size of the color mixing device.

Therefore, the embodiments of the present disclosure provide a color mixing device, which is simple in structure and low cost, and can carry a large number of injection assemblies 4.

It is to be noted that, in the embodiments of the present disclosure, a worker takes a corresponding injection assembly 4 from the mounting cabinet 2 according to a formula, and mounts the injection assembly 4 on the conveying assembly 1-2 positioned at the mounting station. Then, the controller controls the conveying assembly 1-2 to move from the mounting station to the injection station by controlling the drive part, and paint is injected into a container through the discharge nozzle 4-2-1 for color mixing.

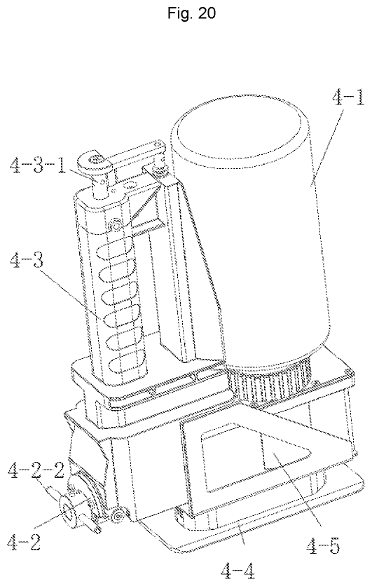

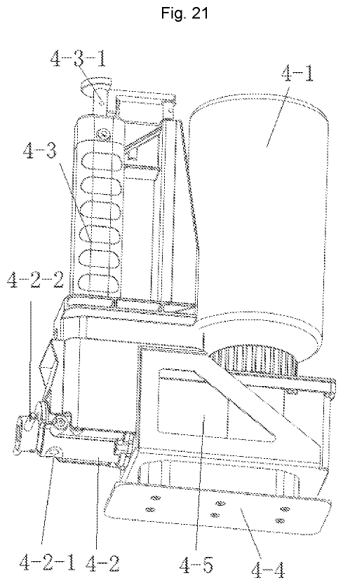

As shown in FIG. 20 and FIG. 21, in the embodiments of the present disclosure, each injection assembly 4 includes a color master batch barrel 4-1, a valve body 4-2, and a pump 4-3. The interior of the color master batch barrel 4-1 forms a material storage cavity. The color master batch barrel 4-1 is connected with the pump 4-3 through the valve body 4-2. The discharge nozzle 4-2-1 is arranged on the valve body 4-2. A valve body toggle rod 4-2-2 is arranged on the valve body 4-2. An injection channel is formed in a valve core of the valve body. The valve body 4-2 may have an opening-closing and flow conversion function by changing the opening-closing relationship between both ends of the injection channel and the discharge nozzle 4-2-1 and the color master batch barrel 4-1. The pump 4-3 may be a volumetric pump that is driven by a stepping motor or a servo motor, for example, a piston pump or a plunger pump. The injection assembly 4 further includes a base 4-4 and a liquid replenishment tank 4-5.

In the embodiments of the present disclosure, the pump 4-3 may be a piston pump, and the piston pump has a piston rod 4-3-1. In this way, the piston rod 4-3-1 may pumps away and discharges color master batches from the color master batch barrel 4-1 by moving up and down.

Of course, in one embodiment, the injection assembly 4 without the liquid replenishment tank 4-5 may also be used.

It is to be noted that, a specific structure and a working principle of the injection assembly 4 are based on the related technology. Please refer to Chinese patent 202022947627.1, which will not be further elaborated here.

It is to be noted that, the controller is arranged to receive external input information, and controls the present color mixing device to orderly complete a paint mixing process according to the input information.

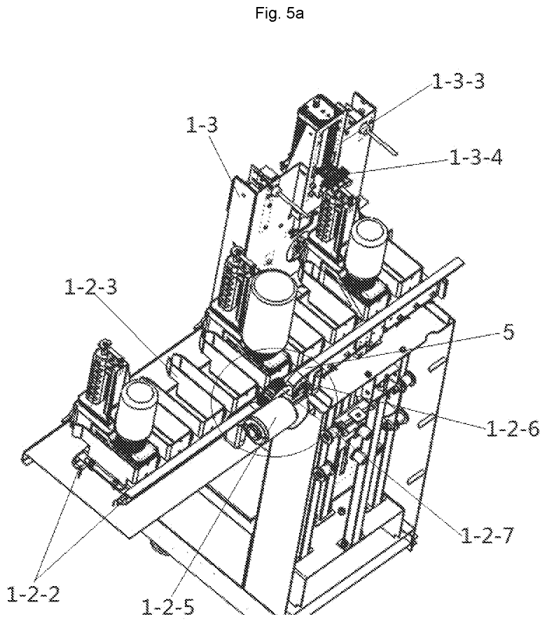

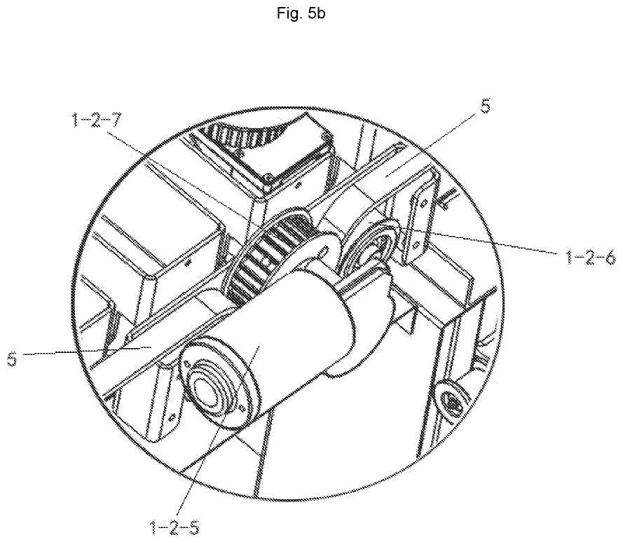

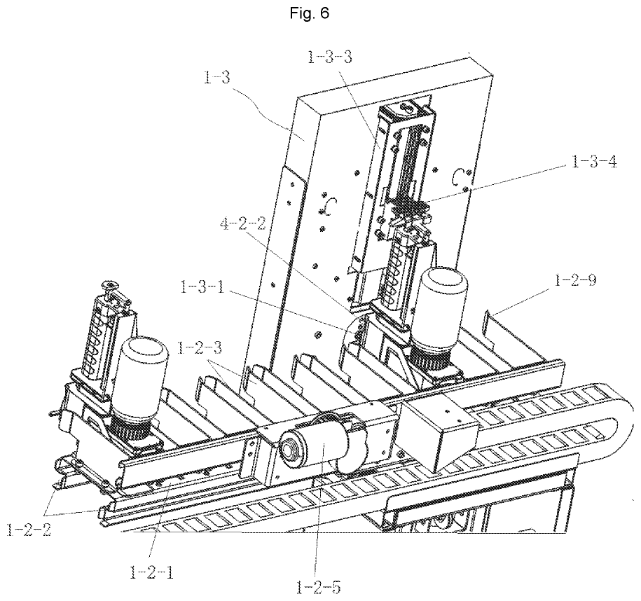

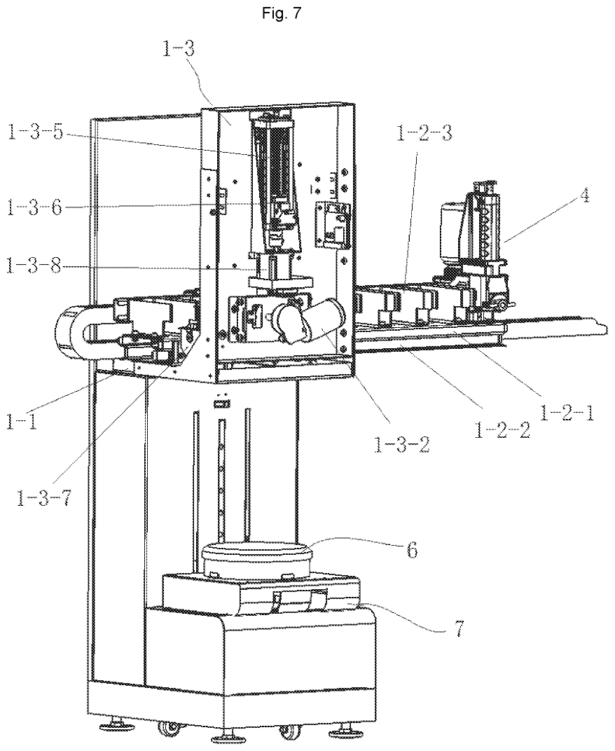

As shown in FIG. 5a to FIG. 9, in the embodiments of the present disclosure, the sliding table assembly 1-1 includes a support frame 1-1-1 and two support rails 1-1-2 arranged on the support frame 1-1-1. Each support rail 1-1-2 extends in the first direction. The two support rails 1-1-2 are arranged at an interval in a second direction perpendicular to the first direction. The conveying assembly 1-2 includes a mounting structure 1-2-1 and two sliding chutes 1-2-2 disposed on two sides of the mounting structure 1-2-1. The two sliding chutes 1-2-2 are arranged corresponding to the two support rails 1-1-2. The sliding chutes 1-2-2 are in sliding fit with the support rails 1-1-2 respectively.

Through the above arrangement, the conveying assembly 1-2 may be arranged on the mounting structure 1-2-1 in a sliding manner. In this way, the conveying assembly 1-2 may move more smoothly in the first direction, so as to facilitate switching of the conveying assembly 1-2 between the mounting station and the injection station.

Further, the support rails 1-1-2 may also limit and support the mounting structure 1-2-1 to limit a displacement of the mounting structure 1-2-1 in a height direction of the mounting cabinet 2.

Specifically, in the embodiments of the present disclosure, the support frame 1-1-1 includes a bottom plate and two side plates arranged oppositely. The two support rails 1-1-2 are mounted on the two side plates, and the mounting structure 1-2-1 is positioned in a space enclosed by the bottom plate and the two side plates.

In the embodiments of the present disclosure, the mounting structure 1-2-1 is made of one plate, and the sliding chute 1-2-2 is formed by stamping and bending the plate.

In some embodiments, the mounting structure 1-2-1 may also be assembled by a plurality of plates.

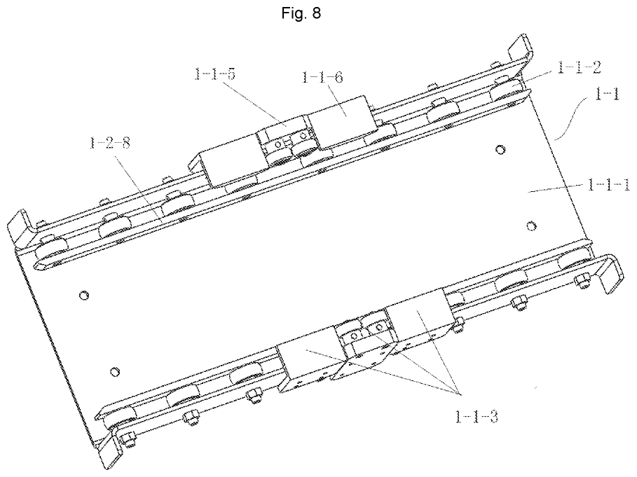

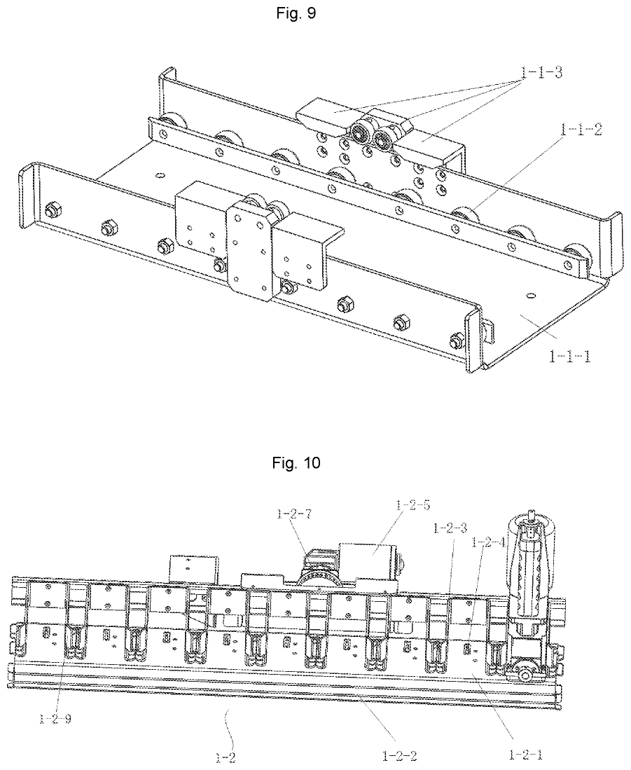

As shown in FIG. 8 and FIG. 9, in the embodiments of the present disclosure, the support rail 1-1-2 includes a plurality of first rolling pieces arranged in the first direction at intervals. Each first rolling piece is rotatably arranged on the support frame 1-1-1.

Through the above arrangement, the friction between an inner wall surface of the sliding chute 1-2-2 and the support rail 1-1-2 may be the rolling friction between the plurality of first rolling pieces and the inner wall surface of the sliding chute 1-2-2. In this way, frictional force can be effectively reduced, so that the conveying assembly 1-2 slides more smoothly relative to the mounting structure 1-2-1.

As shown in FIG. 8, in the embodiments of the present disclosure, the support rail 1-1-2 further includes a plurality of fixed shafts and an anti-dropping plate 1-2-8. The plurality of fixed shafts are penetrate on the support frame 1-1-1 in the second direction. The plurality of fixed shafts are arranged corresponding to the plurality of first rolling pieces. Each rolling piece is rotatably arranged on a periphery of the corresponding fixed shaft. The anti-dropping plate 1-2-8 is arranged to connect the plurality of fixed shafts, and the plurality of first rolling pieces are positioned between the anti-dropping plate 1-2-8 and the support frame 1-1-1.

Through the above arrangement, in one aspect, the first rolling pieces may be rotatably mounted on the support frame 1-1-1. In another aspect, the anti-dropping plate 1-2-8 can solve a problem that the plurality of first rolling pieces are prone to drop from the fixed shafts after rotating for a long time. In another aspect, one anti-dropping plate 1-2-8 is connected to the plurality of fixed shafts, which can improve the integrity of the plurality of first rolling pieces. In this way, when the plurality of first rolling pieces rotate, the problem of shaking of a single first rolling piece and fixed shaft can be avoided, so as to avoid affect the movement of the conveying assembly 1-2 relative to the mounting structure 1-2-1.

Specifically, in the embodiments of the present disclosure, the first rolling piece is a bearing. An inner ring of the bearing is connected with the fixed shaft. An outer ring of the bearing is rotatably arranged relative to the inner ring.

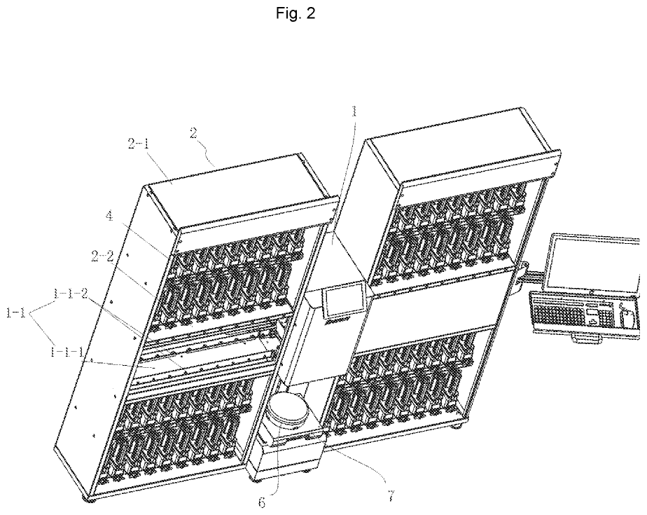

As shown in FIG. 1 and FIG. 2, in the embodiments of the present disclosure, the mounting cabinet 2 includes a first cabinet body 1 and two second cabinet bodies 2-1 positioned on both sides of the first cabinet body 1. A plurality of partition plates 2-2 arranged at intervals in a vertical direction are arranged in the second cabinet body 2-1. One of the partition plates 2-2 is arranged to mount part of the sliding table assembly 1-1. The rest partition plates 2-2 are arranged to support the plurality of injection assemblies 4. The first cabinet body 1 is arranged to mount the rest part of the sliding table assembly 1-1. A material falling channel communicated with the interior of the first cabinet body 1 is formed in the first cabinet body 1. When the conveying assembly 1-2 is positioned at the injection station, the discharge nozzle 4-2-1 is communicated with the material falling channel.

Through the above arrangement, the two second cabinet bodies 2-1 and the one first cabinet body 1 can provide a mounting space for the sliding table assembly 1-1, so that the conveying assembly 1-2 moves on the sliding table assembly 1-1 and is switched between the mounting station and the injection station. The second cabinet bodies 2-1 can also provide a placement space for the plurality of injection assemblies 4 arranged in rows and columns.

When the injection assembly 4 on the conveying assembly 1-2 is positioned on the first cabinet body 1, the conveying assembly 1-2 is positioned at the injection station, and the paint injected from the discharge nozzle 4-2-1 of the injection assembly 4 may fall from a material falling channel. When the conveying assembly 1-2 is positioned in the second cabinet body 2-1, the conveying assembly 1-2 is positioned at the mounting station. A worker may take corresponding injection assemblies 4 from the plurality of partition plates 2-2 in the second cabinet body 2-1 according to a formula and place the injection assemblies 4 on the conveying assembly 1-2 in the second cabinet body 2-1.

Specifically, in the embodiments of the present disclosure, a corresponding indicator lamp is arranged at a position of the partition plate 2-2 where each injection assembly 4 is positioned. The indicator lamp is controlled by the controller. According to the formula of the paint, the controller may control to turn on indicator lamps in front of the injection assemblies 4 that need to be taken and used, so as to facilitate quick taking and using of the worker. Of course, the color master batches in the injection assemblies 4 and the positions of the injection assemblies 4 need to be determined and corresponding to each other, and the positions of the injection assemblies 4 with the same color master batches are corresponding to the same indicator lamp.

As shown in FIG. 1, in the embodiments of the present disclosure, working channels communicated with each other are formed in a right side wall of the second cabinet body 2-1 on a left side and a left side wall of the first cabinet body 1, and working channels communicated with each other are formed in a right side wall of the second cabinet body 2-1 on a right side and a right side wall of the first cabinet body 1. The working channels can avoid the sliding table assembly 1-1 and enable the conveying assembly 1-2 to pass through.

It is to be noted that, in the embodiments of the present disclosure, the structures of the two second cabinet bodies 2-1 may be the same or different. The two second cabinet bodies 2-1 are mainly arranged to store injection assemblies 4 placed therein.

As shown in FIG. 1, in the embodiments of the present disclosure, the plurality of partition plates 2-2 are respectively arranged on an upper part and a lower part of the second cabinet body 2-1 (that is, an upper side and a lower side of the sliding table assembly 1-1). The plurality of injection assemblies 4 may be placed on each partition plate 2-2.

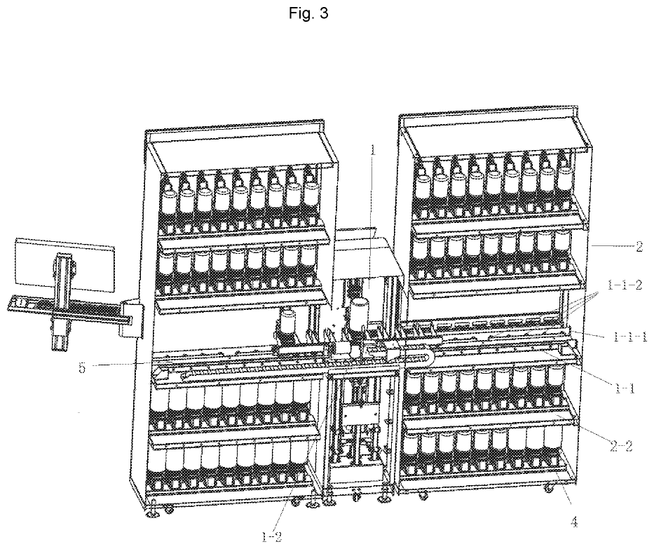

As shown in FIG. 3, in the embodiments of the present disclosure, the sliding table assembly 1-1 may be divided into three sections of sliding table assemblies that are detachably connected, which mainly include a left sliding table assembly, a middle sliding table assembly, and a right sliding table assembly. The left sliding table assembly and the right sliding table assembly are correspondingly arranged in the two second cabinet bodies 2-1. The middle sliding table assembly is arranged in the first cabinet body 1. In this way, the corresponding sliding table assembly may be mounted in the corresponding cabinet body first, and then the left sliding table assembly, the middle sliding table assembly, and the right sliding table assembly are connected, so as to facilitate assembling.

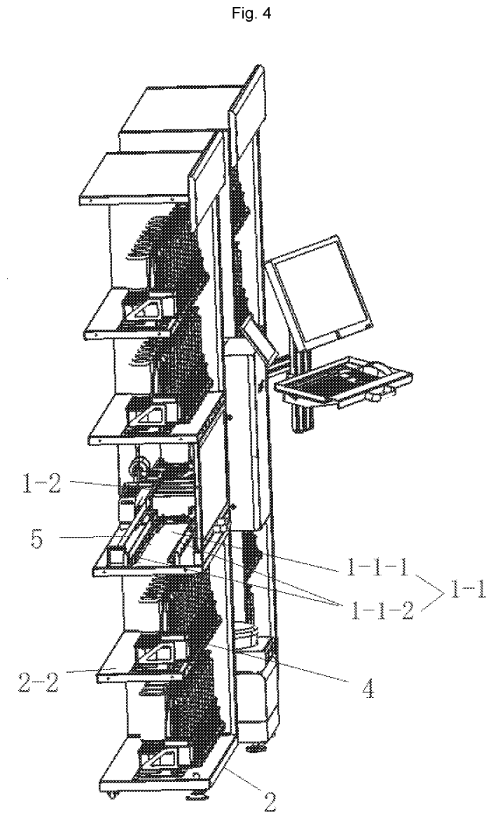

As shown in FIG. 4 and FIG. 5a, in the embodiments of the present disclosure, the color mixing device further includes a lifting mechanism. The lifting mechanism includes a lifting mechanism mounting part 1-3 arranged in the first cabinet body 1. The middle sliding table assembly and the lifting mechanism mounting part 1-3 are arranged at an interval to form a material falling path that allows the discharge nozzle 4-2-1 to discharge. The material falling path is positioned above the material falling channel and is communicated with the material falling channel.

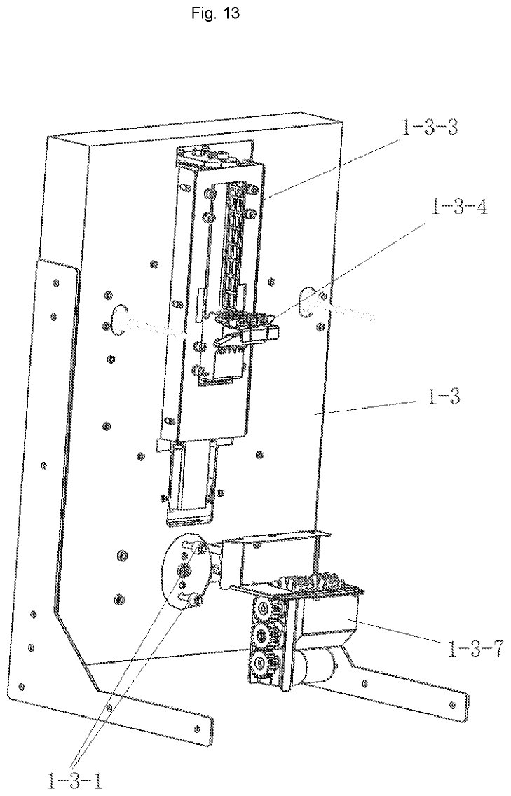

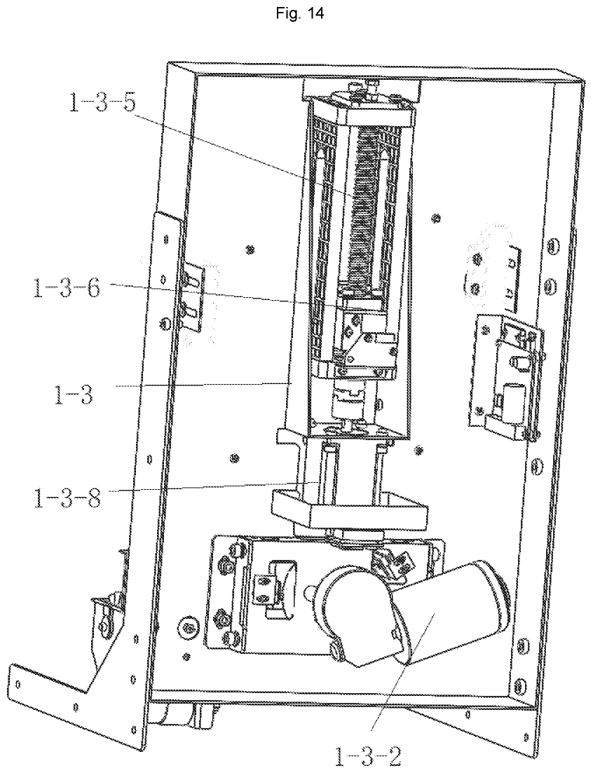

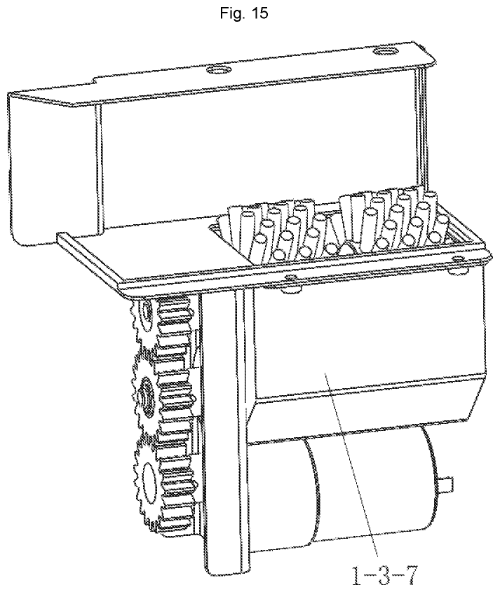

Specifically, as shown in FIG. 13 and FIG. 14, in the embodiments of the present disclosure, the lifting mechanism further includes a toggle rod of a toggle valve body 1-3-1 rotatably arranged on the lifting mechanism mounting part 1-3 and a valve motor 1-3-2 arranged to drive the toggle rod of the toggle valve body 1-3-1 to rotate. The toggle rod of the toggle valve body 1-3-1 may drive the valve body toggle rod 4-2-2 to rotate after fitting with the valve body toggle rod 4-2-2, so as to communicate or close the injection channel and the discharge nozzle 4-2-1.

Specifically, as shown in FIG. 5a to FIG. 7, FIG. 13, and FIG. 14, in the embodiments of the present disclosure, the lifting mechanism further includes a linear drive mechanism 1-3-3 that is arranged on the lifting mechanism mounting part 1-3 and is positioned above the toggle rod of the toggle valve body 1-3-1 and a pull rod head baffle 1-3-4 that is connected with an output end of the linear drive mechanism 1-3-3 and can move up and down. An assembling groove is formed in the pull rod head baffle 1-3-4. In a process of switching the injection assembly 4 between the mounting station and the injection station, an end part of the piston rod 4-3-1 can move reciprocally in the first direction, so as to leave or enter the assembling groove. When the injection assembly 4 is positioned at the injection station, the end part of the piston rod 4-3-1 is cooperated with the assembling groove, and the output end of the linear drive mechanism 1-3-3 can drive the pull rod head baffle 1-3-4 to move reciprocally in the height direction of the mounting cabinet 2, so as to lift or press the piston rod 4-3-1 of the piston pump, thereby pumping the color master batches away from the color master batch barrel and discharging the color master batches in fit with the toggle rod of the toggle valve body 1-3-1.

In the embodiments of the present disclosure, the linear drive mechanism 1-3-3 may be a lead screw-nut mechanism. The lifting mechanism further includes a servo motor 1-3-8 that is arranged on the lifting mechanism mounting part 1-3 and drives a lead screw 1-3-5 to rotate. A nut 1-3-6 is arranged on the lead screw 1-3-5, and the nut 1-3-6 is connected with the pull rod head baffle 1-3-4. The piston rod is moved up and down by moving the nut 1-3-6 up and down, so as to pump the color master batches away from the color master batch barrel and discharge the color master batches.

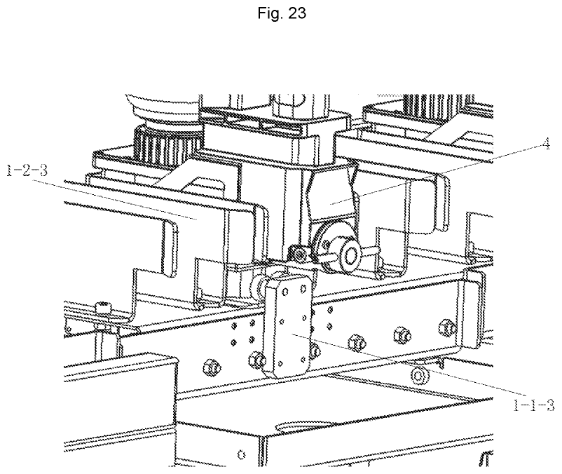

As shown in FIG. 8, FIG. 9, and FIG. 20 to FIG. 23, in the embodiments of the present disclosure, the sliding table assembly 1-1 further includes a compression component 1-1-3 positioned above the support rail 1-1-2 and arranged on support frame 1-1-1. When the conveying assembly 1-2 is positioned at the injection station, the compression component 1-1-3 is capable of compressing against the injection assembly 4.

In the above technical solution, after the injection assembly 4 injects paint, and when the pull rod head baffle 1-3-4 moves upwards, the compression component 1-1-3 may compress the injection assembly 4 on the conveying assembly 1-2, which facilitates separating the end part of the piston rod 4-3-1 from the assembling groove of the pull rod head baffle 1-3-4, and can also avoid a problem that the injection assembly 4 is separated from the conveying assembly 1-2 or shakes caused by lifting the overall injection assembly 4.

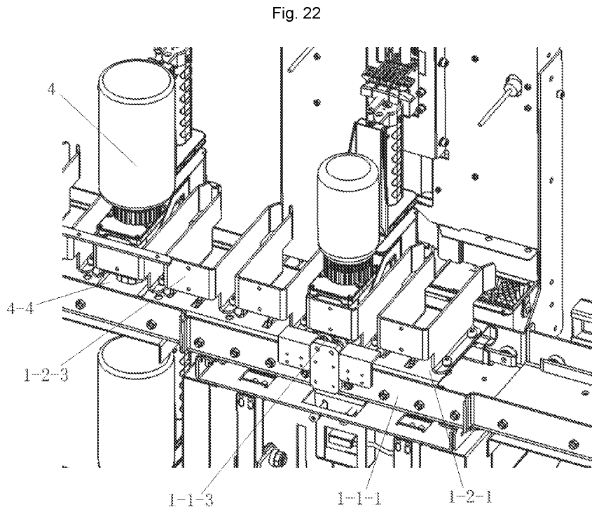

As shown in FIG. 22, in the embodiments of the present disclosure, the compression component 1-1-3 compresses against the base 4-4 of the injection assembly 4.

In the embodiments of the present disclosure, the support rail 1-1-2 is arranged at a lower position of the side plate of the support frame 1-1-1, and the compression component 1-1-3 is arranged at an upper position of the side plate of the support frame 1-1-1.

As shown in FIG. 8 and FIG. 9, in the embodiments of the present disclosure, the compression component 1-1-3 includes a plurality of second rolling pieces and a connecting piece 1-1-5. The plurality of second rolling pieces are arranged in the first direction in sequence. Each of the second rolling pieces is rotatably connected with the connecting piece 1-1-5, and the each second rolling piece is mounted on the support frame 1-1-1 by the connecting piece.

In the above technical solution, in a process that the conveying assembly 1-2 drives the injection assemblies 4 to move reciprocally in the first direction, the second rolling pieces may roll on the bases 4-4 of the plurality of the injection assemblies 4, so that the friction between the bases 4-4 and the compression component 1-1-3 is rolling friction. In this way, frictional force can be effectively reduced, so that the conveying assembly 1-2 slides more smoothly relative to the mounting structure 1-2-1.

Specifically, in the embodiments of the present disclosure, the second rolling piece is a bearing. The compression component 1-1-3 further includes a fixed shaft arranged on the connecting piece 1-1-5 in a penetrating manner. An inner ring of the bearing is connected with the fixed shaft. An outer ring of the bearing is rotatable relative to the inner ring.

As shown in FIG. 8, in the embodiments of the present disclosure, the compression component 1-1-3 further includes two guide pieces 1-1-6 that are connected with the support frame 1-1-1. The two guide pieces 1-1-6 are arranged in the first direction at an interval, and the two guide pieces 1-1-6 are respectively positioned on two sides of the plurality second rolling pieces.

In the above technical solution, the two guide pieces 1-1-6 are arranged. In a process that the conveying assembly 1-2 drives the injection assemblies 4 to move reciprocally in the first direction, the two guide pieces 1-1-6 can achieve a guide effect, so that the conveying assembly 1-2 enters below the second rolling pieces and is compressed and positioned.

Specifically, in the embodiments of the present disclosure, the guide piece 1-1-6 includes three plate sections connected in sequence. Two adjacent plate sections are arranged at an included angle. A first plate section is connected with the support frame 1-1-1. A second plate section and a third plate section are positioned on a side of the second rolling piece. The first plate section and the third plate section are positioned on the same side of the second plate section.

As shown in FIG. 5a, FIG. 5b, and FIG. 10 to FIG. 12, in the embodiments of the present disclosure, the drive part includes a belt 5, a mounting frame, a drive motor 1-2-5, a belt pulley 1-2-7, and an auxiliary wheel 1-2-6. Wherein, the belt 5 is fixed to the interior of the mounting cabinet 2. The belt 5 extends in the first direction. The mounting frame is positioned on a side of the conveying assembly 1-2 and is connected with the conveying assembly 1-2. The drive motor 1-2-5 is mounted on the conveying assembly 1-2 by the mounting frame. The controller is connected with the drive motor 1-2-5 and controls the drive motor 1-2-5. The belt pulley 1-2-7 is in transmission connection with an output end of the drive motor 1-2-5. The output end drives the belt pulley 1-2-7 to rotate relative to the conveying assembly 1-2. The auxiliary wheel 1-2-6 is rotatably arranged on the mounting frame. In the first direction, at least one side of the belt pulley 1-2-7 is provided with the auxiliary wheel 1-2-6. Part of the belt 5 winds the belt pulley 1-2-7 and the auxiliary wheel 1-2-6, so that the belt pulley 1-2-7 and the auxiliary wheel 1-2-6 drive the conveying assembly 1-2 to move in the first direction.

In the above technical solution, the belt 5 is fixed to the interior of the mounting cabinet 2, and both the belt pulley 1-2-7 and the auxiliary wheel 1-2-6 are rotatably arranged relative to the belt 5, so that the rotations of the belt pulley 1-2-7 and the auxiliary wheel 1-2-6 relative to the belt 5 may be converted into the movement of the belt pulley 1-2-7 and the auxiliary wheel 1-2-6 relative to the belt 5 by using the frictional force between the belt 5 and the belt pulley 1-2-7 and the frictional force between the belt 5 and the auxiliary wheel 1-2-6. Therefore, the belt pulley 1-2-7 and the auxiliary wheel 1-2-6 can drive the conveying assembly 1-2 to move in the direction where the belt 5 is positioned to switch the conveying assembly 1-2 between the mounting station and the injection station.

In the embodiments of the present disclosure, the drive part includes two auxiliary wheels 1-2-6. The two auxiliary wheels 1-2-6 are positioned on two sides of the belt pulley 1-2-7, so that the frictional force can be increased. Therefore, the conveying assembly 1-2 moves better.

In the embodiments of the present disclosure, in the first direction, the belt 5 penetrates through the overall mounting cabinet 2, and the belt 5 winds the auxiliary wheel 1-2-6 and the belt pulley 1-2-7.

As shown in FIG. 10 to FIG. 12, in the embodiments of the present disclosure, the conveying assembly 1-2 further includes a plurality of fixed frames 1-2-3 arranged on the mounting structure 1-2-1. The plurality of fixed frames 1-2-3 are arranged in the first direction. A mounting groove and an opening communicated with mounting groove are formed in each fixed frame 1-2-3. The injection assembly 4 is capable of being inserted in the mounting groove through the opening.

Through the above arrangement, after a worker selects a corresponding injection assembly 4 from the mounting cabinet 2 according to the formula, the injection assembly 4 may be quickly inserted into the mounting groove, so as to realize quick mounting of the injection assembly 4. After injection is completed, the injection assembly 4 may be conveniently taken from the mounting groove and place to an original position, so as to realize quick dismounting of the injection assembly 4, which facilitates the improvement of the work efficiency and the reduction of difficulties in mounting and dismounting.

Further, the plurality of fixed frames 1-2-3 are arranged, so that the conveying assembly 1-2 can convey the plurality of injection assemblies 4 at one time, which can improve the color mixing efficiency.

In the embodiments of the present disclosure, the drive motor 1-2-5 is mounted on the fixed frame 1-2-3 through the mounting frame, and is positioned on a side, deviating from the injection assembly 4, of the fixed frame 1-2-3.

In one embodiment, the drive motor 1-2-5 may also be mounted on the mounting structure 1-2-1.

As shown in FIG. 10, in the embodiments of the present disclosure, the fixed frame 1-2-3 includes three connecting plates connected in sequence. Two adjacent connecting plates are arranged at an included angle. The three connecting plates enclose to form a U-shaped structure with an opening. The fixed frame 1-2-3 further includes two guide plates 1-2-9 respectively connected with a first connecting plate and a third connecting plate of the three connecting plates. The two guide plates 1-2-9 are respectively arranged at an angle with the corresponding connecting plate. From the mounting groove to the opening (that is, in a direction away from the mounting groove), a spacing distance between the two guide plates 1-2-9 gradually increases.

Through the above arrangement, the two guide plates 1-2-9 may achieve a guide effect, which facilitates inserting the injection assembly 4 into the opening by the worker, thereby reducing the difficulty in mounting the injection assembly 4 and improving the efficiency of mounting the injection assembly 4 by the worker.

It is to be noted that, in the embodiments of the present disclosure, the third connecting plate refers to a connecting plate corresponding to the opening.

As shown in FIG. 22, in the embodiments of the present disclosure, the first connecting plate and the third connecting plate of the three connecting plates are respectively connected with the mounting structure 1-2-1. There is a spacing distance between the second connecting plate of the three connecting plates and the mounting structure 1-2-1.

Through the above arrangement, the fixed frame 1-2-3 can be connected to the mounting structure 1-2-1, and the fixed frame 1-2-3 can also avoid the compression component 1-1-3, so that the compression component 1-1-3 compresses the base 4-4 of the injection assembly 4 through the spacing between the second connecting plate and the mounting structure 1-2-1.

As shown in FIG. 10 to FIG. 12, in the embodiments of the present disclosure, the color mixing device further includes a plurality of position sensors 1-2-4 arranged corresponding to the plurality of fixed frames 1-2-3. The position sensors 1-2-4 are connected with the controller and are controlled by the controller. The controller controls the conveying assembly 1-2 to move according to the information transmitted by the position sensors 1-2-4.

Through the above arrangement, the position sensors 1-2-4 may identify whether the injection assembly 4 is mounted on each of the plurality of fixed frames 1-2-3 of the conveying assembly 1-2, and feeds information back to the controller. In this way, the controller can control the movement of the conveying assembly 1-2, and the fixed frame 1-2-3 mounted with the injection assembly 4 is moved to the injection station, thereby realizing injection of paint.

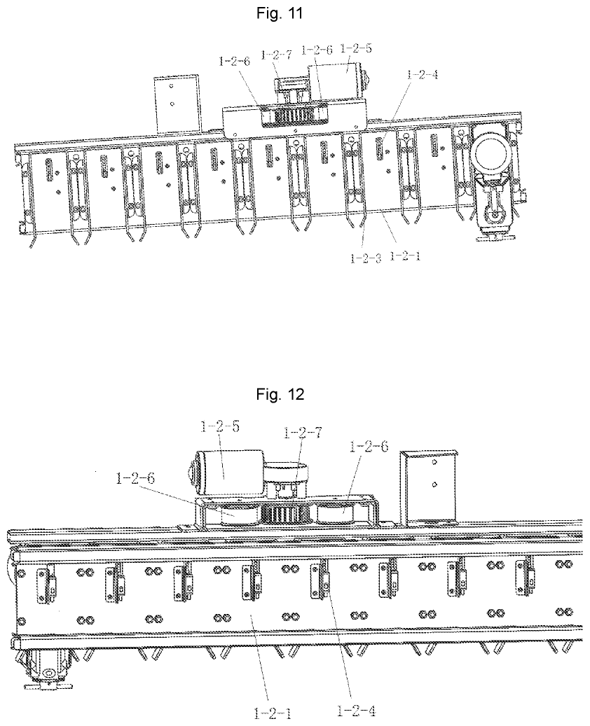

As shown in FIG. 11 and FIG. 12, in the embodiments of the present disclosure, each position sensor 1-2-4 is arranged on a side, deviating from fixed frame 1-2-3, of the mounting structure 1-2-1 and a plurality of through grooves corresponding to detection ends of the plurality of position sensors 1-2-4 are formed in the mounting structure 1-2-1.

Through the above arrangement, it is convenient for the each position sensor 1-2-4 to detect whether the fixed frame 1-2-3 is mounted with the injection assembly 4, and it can also make a side, facing the fixed frame 1-2-3, of the mounting structure 1-2-1 a plane. In this way, the injection assembly 4 can be placed on the mounting structure 1-2-1 more stably.

In one embodiment, the position sensors 1-2-4 may also be mounted at other positions that are corresponding to the fixed frames 1-2-3 and facilitate detecting.

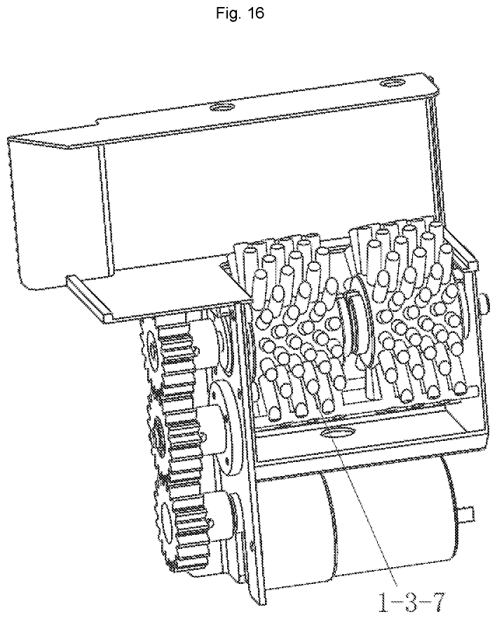

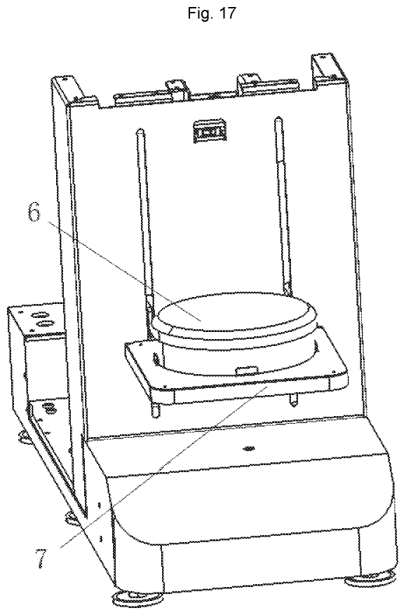

As shown in FIG. 13, FIG. 15, and FIG. 16, in the embodiments of the present disclosure, a cleaning box assembly 1-3-7 is also arranged on the lifting mechanism mounting part 1-3. The lifting mechanism mounting part 1-3-7 is positioned on a side, facing the injection assembly 4, of the lifting mechanism mounting part 1-3, and the cleaning box assembly 1-3-7 is positioned on a lower side of the toggle rod of the toggle valve body 1-3-1. The cleaning box assembly 1-3-7 includes a box body mounted on the lifting mechanism mounting part 1-3 and a cleaning roller arranged in the box body. The cleaning roller is connected with an output shaft of the motor, so as to realize the rotation of the cleaning roller. In this way, when the injection assembly 4 moves reciprocally in the first direction, the discharge nozzle 4-2-1 of the injection assembly 4 can be in contact with the cleaning roller, so as to clean color paste remaining on the discharge nozzle 4-2-1, thereby ensuring the mixing quality of the paint, and preventing the discharge nozzle 4-2-1 from being blocked by the remaining color paste.

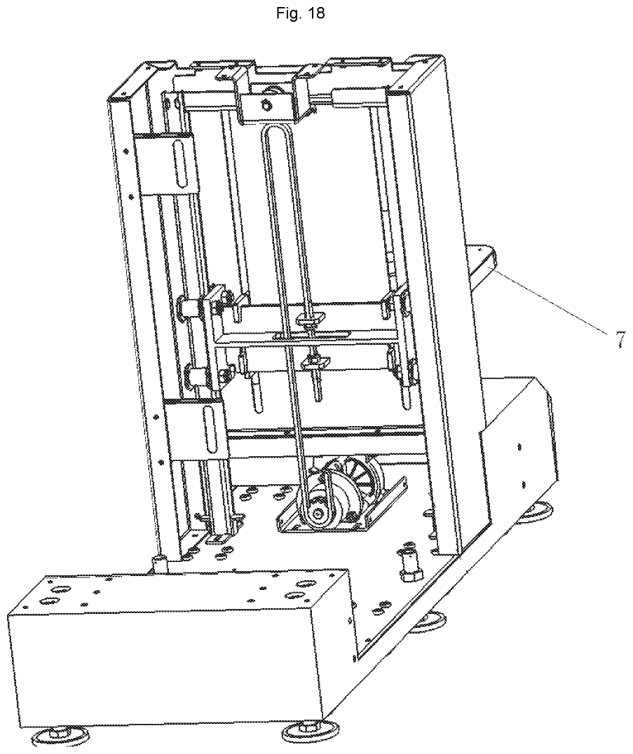

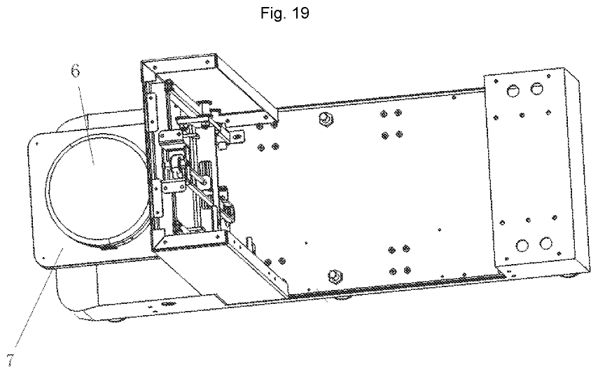

As shown in FIG. 17 to FIG. 19, in the embodiments of the present disclosure, if a mass measuring method is used, the color mixing device may further include a rack arranged below the first cabinet body 1 and an electronic scale 6 arranged on the rack. The rack 6 is positioned below the material falling channel.

In one embodiment, if a volume metering method is used, the electronic scale 6 may not be arranged.

As shown in FIG. 17 to FIG. 19, in the embodiments of the present disclosure, the color mixing device further includes a lifting platform 7 arranged on the rack. The electronic scale 6 is arranged on the lifting platform 7. The lifting platform 7 is movably arranged in the height direction of the mounting cabinet 2 relative to the rack.

In other embodiments, the lifting platform 7 may also be arranged in other forms, and particularly, a lifting mechanism of the lifting platform 7 may be a lead screw, an air cylinder, an oil cylinder, or the like.

A working process of the device is as follows.

Step one, at an initial position of mixing paint, the conveying assembly 1-2 stops on the sliding table assembly 1-1 corresponding to the second cabinet body 2-1 on the left side or the sliding table assembly 1-1 corresponding to the second cabinet body 2-1 on the right side (that is, the mounting station), the controller controls the indicator lamps at the corresponding injection assemblies 4 in the second cabinet body 2-1 to light up in sequence according to the input paint formula that needs to be mixed. The worker inserts the injection assemblies 4 that need to be used into the fixed frames 1-2-3 in sequence.

Step two, the controller controls the drive motor 1-2-5 to work, and the belt pulley 1-2-7 drives the conveying assembly 1-2 to move to the lifting mechanism mounting part 1-3 along the belt 5.

Step three, under the control of the controller, the injection assembly 4 in each fixed frame 1-2-3 cooperates with the lifting mechanism mounting part 1-3 in sequence, that is, the toggle rod of the toggle valve body 1-3-1 is combined with the valve body toggle rod 4-2-2 of the injection assembly 4, the pull rod head baffle 1-3-4 lifts up or presses down the piston rod 4-3-1 of the piston pump. Through the cooperation of the injection assembly 4 and the lifting mechanism mounting part 1-3, the color master batches in the color master batch barrel is pumped out from the discharge nozzle 4-2-1 through the valve body 4-2, and enters a paint receiving container placed on the lifting platform 7 through the material falling channel. The paint that needs to be mixed is in the paint receiving container.

From the above description, it can be seen that, the above embodiments of the present disclosure achieve the following technical effects: in one aspect, compared with moving the injection assembly from a pre-discharge station to a position of a discharge actuating mechanism by using a manipulator part in the related technology, in the present embodiment, the sliding table assembly arranged in the first direction and the conveying assembly movably arranged on the sliding table assembly are arranged, so that the conveying assembly has the mounting station and the injection station relative to the mounting cabinet, and the drive part is arranged to drive the conveying assembly to switch between the mounting station and the injection station. In this way, the injection assembly may be moved from the mounting station (the pre-discharge station) to the injection station (the position of the discharge actuating mechanism) without the manipulator part, so as to simplify the structure of the color mixing device and reduce the size of the color mixing device, thereby reducing the production cost of the color mixing device. In another aspect, compared with a turntable type color mixing device in the related technology, in the present embodiment, the mounting cabinet is mounted, and the plurality of injection assemblies can be arranged inside the mounting cabinet in rows and columns. In this way, the problem of complexity of a drive mechanism and a transmission mechanism caused by increasing the size of a turntable can be avoided in a case that a large number of injection assemblies can be placed, so as to simplify the structure of the color mixing device and reduce the size of the color mixing device.

The above is only some embodiments of the present disclosure and is not intended to limit the present disclosure. For those skilled in the art, the present disclosure is susceptible to various modifications and changes. Any modifications, equivalent replacements, improvements and the like made within the spirit and principle of the present disclosure shall fall within the scope of protection of the present disclosure.

What is claimed is:

1. A color mixing device, comprising:
a mounting cabinet, a sliding table assembly arranged in a first direction being mounted in the mounting cabinet;
a plurality of injection assemblies, arranged in the mounting cabinet in rows and columns, in a height direction of the mounting cabinet, the injection assemblies being arranged on at least one side of the sliding table assembly, and each injection assembly having a material storage cavity capable of storing a material and a discharge nozzle that is communicated with the material storage cavity;
a conveying assembly, arranged in the mounting cabinet, the conveying assembly being movably arranged on the sliding table assembly in the first direction, the conveying assembly having a mounting station and an injection station relative to the mounting cabinet, when the conveying assembly is positioned at the mounting station, at least one injection assembly being capable of being mounted on the conveying assembly, and when the conveying assembly is positioned at the injection station, the at least one injection assembly positioned on the conveying assembly being capable of injecting a material through a corresponding discharge nozzle;
a drive part, connected with the conveying assembly, the drive part being arranged to drive the conveying assembly to move, so that the conveying assembly is switched between the mounting station and the injection station; and
a controller, connected with the drive part and is able to control the drive part.

2. The color mixing device according to claim 1, wherein the sliding table assembly comprises a support frame and two support rails arranged on the support frame; each support rail extends in the first direction; the two support rails are arranged at an interval in a second direction perpendicular to the first direction;
the conveying assembly comprises a mounting structure and two sliding chutes formed in two sides of the mounting structure; the two sliding chutes are arranged corresponding to the two support rails; and the sliding chutes are in sliding fit with the support rails.

3. The color mixing device according to claim 2, wherein each support rail comprises a plurality of first rolling pieces arranged in the first direction at intervals; and the plurality of first rolling pieces are rotatably arranged on the support frame.

4. The color mixing device according to claim 3, wherein the each support rail further comprises:
a plurality of fixed shafts, arranged on the support frame along the second direction in a penetrating manner, the plurality of fixed shafts being arranged corresponding to the plurality of first rolling pieces, and each first rolling piece being rotatably arranged on a periphery of a corresponding fixed shaft; and
an anti-dropping plate, arranged to connect the plurality of fixed shafts, and the plurality of first rolling pieces being positioned between the anti-dropping plate and the support frame.

5. The color mixing device according to claim 2, wherein the sliding table assembly further comprises a compression component positioned above each support rail and arranged on the support frame; and when the conveying assembly is positioned at the injection station, the compression component is capable of compressing against the injection assembly.

6. The color mixing device according to claim 5, wherein the compression component comprises:
a plurality of second rolling pieces, arranged in the first direction in sequence; and
a connecting piece, each second rolling piece being rotatably connected with the connecting piece, and the each second rolling piece being mounted on the support frame through the connecting piece.

7. The color mixing device according to claim 6, wherein the compression component further comprises:
two guide pieces, connected with the support frame, the two guide pieces being arranged in the first direction at an interval, and the two guide pieces being respectively positioned on two sides of the plurality of second rolling pieces.

8. The color mixing device according to claim 1, wherein the drive part comprises:
a belt, fixed to an interior of the mounting cabinet, the belt extending in the first direction;
a mounting frame, positioned on a side of the conveying assembly and connected with the conveying assembly; a drive motor, mounted on the conveying assembly through the mounting frame, the controller is connected with the drive motor and is able to control the drive motor;
a belt pulley, in transmission connection with an output end of the drive motor, and the output end is capable of driving the belt pulley to rotate relative to the conveying assembly; and
an auxiliary wheel, rotatably arranged on the mounting frame, in the first direction, the auxiliary wheel being arranged on at least one side of the belt pulley, and part of the belt winding the belt pulley and the auxiliary wheel, so that the belt pulley and the auxiliary wheel are able to drive the conveying assembly to move in the first direction.

9. The color mixing device according to claim 2, wherein the conveying assembly further comprises a plurality of fixed frames arranged on the mounting structure; the plurality of fixed frames are arranged in the first direction; a mounting groove and an opening communicated with the mounting groove are formed in each fixed frame; and
each injection assembly is capable of being inserted in the mounting groove through the opening.

10. The color mixing device according to claim 9, wherein the each fixed frame comprises three connecting plates connected in sequence; two adjacent connecting plates are arranged at an angle; the three connecting plates enclose to form a U-shaped structure with the opening;
the each fixed frame further comprises two guide plates respectively connected with a first connecting plate and a third connecting plate of the three connecting plates; the two guide plates are respectively arranged at an angle with a correspondingly connecting plate; and from the mounting groove to the opening, a spacing distance between the two guide plates gradually increases.

11. The color mixing device according to claim 10, wherein the first connecting plate and the third connecting plate of the three connecting plates are respectively connected with the mounting structure; and there is a spacing distance between a second connecting plate of the three connecting plates and the mounting structure.

12. The color mixing device according to claim 9, further comprising a plurality of position sensors arranged corresponding to the plurality of fixed frames; the plurality of position sensors are connected with the controller and are controlled by the controller; and the controller controls the conveying assembly to move according to information transmitted by the plurality of position sensors.

13. The color mixing device according to claim 12, wherein each position sensor is arranged on a side, deviating from the fixed frame, of the mounting structure; and a plurality of through grooves corresponding to detection ends of the plurality of position sensors are formed in the mounting structure.

14. The color mixing device according to claim 1, wherein the mounting cabinet comprises a first cabinet body and a second cabinet body positioned on at least one side of the first cabinet body; a plurality of partition plates arranged at intervals in a vertical direction are arranged in each second cabinet body; one of the partition plates is arranged to mount part of the sliding table assembly; the rest partition plates are arranged to support the plurality of injection assemblies;
the first cabinet body is arranged to mount a rest part of the sliding table assembly; a material falling channel communicated with an interior of the first cabinet body is formed in the first cabinet body; and when the conveying assembly is positioned at the injection station, the discharge nozzle is communicated with the material falling channel.

15. The color mixing device according to claim 2, wherein the drive part comprises:
a belt, fixed to an interior of the mounting cabinet, the belt extending in the first direction;
a mounting frame, positioned on a side of the conveying assembly and connected with the conveying assembly; a drive motor, mounted on the conveying assembly through the mounting frame, the controller is connected with the drive motor and is able to control the drive motor;
a belt pulley, in transmission connection with an output end of the drive motor, and the output end is capable of driving the belt pulley to rotate relative to the conveying assembly; and
an auxiliary wheel, rotatably arranged on the mounting frame, in the first direction, the auxiliary wheel being arranged on at least one side of the belt pulley, and part of the belt winding the belt pulley and the auxiliary wheel, so that the belt pulley and the auxiliary wheel are able to drive the conveying assembly to move in the first direction.

16. The color mixing device according to claim 3, wherein the drive part comprises:
a belt, fixed to an interior of the mounting cabinet, the belt extending in the first direction;
a mounting frame, positioned on a side of the conveying assembly and connected with the conveying assembly; a drive motor, mounted on the conveying assembly through the mounting frame, the controller is connected with the drive motor and is able to control the drive motor;
a belt pulley, in transmission connection with an output end of the drive motor, and the output end is capable of driving the belt pulley to rotate relative to the conveying assembly; and
an auxiliary wheel, rotatably arranged on the mounting frame, in the first direction, the auxiliary wheel being arranged on at least one side of the belt pulley, and part of the belt winding the belt pulley and the auxiliary wheel, so that the belt pulley and the auxiliary wheel are able to drive the conveying assembly to move in the first direction.

17. The color mixing device according to claim 4, wherein the drive part comprises:
a belt, fixed to an interior of the mounting cabinet, the belt extending in the first direction;
a mounting frame, positioned on a side of the conveying assembly and connected with the conveying assembly; a drive motor, mounted on the conveying assembly through the mounting frame, the controller is connected with the drive motor and is able to control the drive motor;
a belt pulley, in transmission connection with an output end of the drive motor, and the output end is capable of driving the belt pulley to rotate relative to the conveying assembly; and
an auxiliary wheel, rotatably arranged on the mounting frame, in the first direction, the auxiliary wheel being arranged on at least one side of the belt pulley, and part of the belt winding the belt pulley and the auxiliary wheel, so that the belt pulley and the auxiliary wheel are able to drive the conveying assembly to move in the first direction.

18. The color mixing device according to claim 5, wherein the drive part comprises:
a belt, fixed to an interior of the mounting cabinet, the belt extending in the first direction;
a mounting frame, positioned on a side of the conveying assembly and connected with the conveying assembly; a drive motor, mounted on the conveying assembly through the mounting frame, the controller is connected with the drive motor and is able to control the drive motor;
a belt pulley, in transmission connection with an output end of the drive motor, and the output end is capable of driving the belt pulley to rotate relative to the conveying assembly; and
an auxiliary wheel, rotatably arranged on the mounting frame, in the first direction, the auxiliary wheel being arranged on at least one side of the belt pulley, and part of the belt winding the belt pulley and the auxiliary wheel, so that the belt pulley and the auxiliary wheel are able to drive the conveying assembly to move in the first direction.

19. The color mixing device according to claim 6, wherein the drive part comprises:
a belt, fixed to an interior of the mounting cabinet, the belt extending in the first direction;
a mounting frame, positioned on a side of the conveying assembly and connected with the conveying assembly; a drive motor, mounted on the conveying assembly through the mounting frame, the controller is connected with the drive motor and is able to control the drive motor;
a belt pulley, in transmission connection with an output end of the drive motor, and the output end is capable of driving the belt pulley to rotate relative to the conveying assembly; and
an auxiliary wheel, rotatably arranged on the mounting frame, in the first direction, the auxiliary wheel being arranged on at least one side of the belt pulley, and part of the belt winding the belt pulley and the auxiliary wheel, so that the belt pulley and the auxiliary wheel are able to drive the conveying assembly to move in the first direction.

20. The color mixing device according to claim 7, wherein the drive part comprises:
a belt, fixed to an interior of the mounting cabinet, the belt extending in the first direction;
a mounting frame, positioned on a side of the conveying assembly and connected with the conveying assembly; a drive motor, mounted on the conveying assembly through the mounting frame, the controller is connected with the drive motor and is able to control the drive motor;
a belt pulley, in transmission connection with an output end of the drive motor, and the output end is capable of driving the belt pulley to rotate relative to the conveying assembly; and
an auxiliary wheel, rotatably arranged on the mounting frame, in the first direction, the auxiliary wheel being arranged on at least one side of the belt pulley, and part of the belt winding the belt pulley and the auxiliary wheel, so that the belt pulley and the auxiliary wheel are able to drive the conveying assembly to move in the first direction.
